(19) United States
(12) Patent Application Publication
(10) Pub. No.: US 2012/0021189 A1
(43) Pub. Date: Jan. 26, 2012

(54) Pre-coated surfaces for analysis

(75) Inventors: Paul E. Laibinis, Nashville, TN (US); Richard Caprioli, Nashville, TN (US); Zhou Xu, Nashville, TN (US); Junhai Yang, Nashville, TN (US)

(73) Assignee: Vanderbilt University, Nashville, TN (US)

(21) Appl. No.: 13/068,802

(22) Filed: May 20, 2011

Related U.S. Application Data
(60) Provisional application No. 61/347,340, filed on May 21, 2010.

(51) Int. Cl. B41M 5/00; B05D 7/14; B05D 1/32; B05D 5/00; B05D 1/36

(52) U.S. Cl. 428/195.1; 427/256; 427/258; 427/282; 427/287

(57) ABSTRACT

Sample preparation can be a tedious and time consuming task. For example, MALDI imaging of tissue samples can require the tedious process of hand or robotically spotting solutions containing chemical species referred to as “matrix” onto a tissue sample prior its mass spectral analysis. Provided is a process for preparing a sample comprising immersing a solid support that has a surface comprising a first part that is more hydrophilic than a second part into a target compound solution, wherein the target compound is deposited primarily onto the more hydrophilic part; and/or applying and evaporating the target compound solution onto the substrate to produce the pre-coated substrate. A tissue or other sample may then be placed on the substrate for analysis.

This application claims benefit of priority to U.S. Provisional Application Ser. No. 61/347,340, filed May 21, 2010, the entire contents of which are hereby incorporated by reference.

This invention was made with government support under grant 5 R01 GM 58008-10 awarded by the National Institutes of Health. The government has certain rights in the invention.

### BACKGROUND OF THE INVENTION

1. Field of the Invention

The present invention relates generally to the fields of sample preparation. More particularly, it concerns methods and compositions for developing a fast, cheap and high throughput sample preparation method.

2. Description of the Related Art

Manual spraying of matrices solution on top of tissue section, for example for MALDI imaging, is low cost and gives good sensitivity but poor reproducibility, as homogeneous high density coatings are difficult to achieve especially for peptides and proteins unless expensive robotics are employed. Automatic spotters have excellent reproducibility but are expensive and need a lot maintenance. Pre-coating the MALDI target with matrices by nebulized spray or sublimation, conversely, can give great spatial resolution (˜5 μm) but generally can only ionize species with m/z less than 2000 and therefore are generally are not optimal for mid to high molecular weight analytes. This mass range primarily contains lipids or phospholipids with the dry matrix layer, which lacks the ability to extract proteins and peptides.

### SUMMARY OF THE INVENTION

In some aspects, the invention provides a method of producing a pre-coated substrate comprising: (a) treating a substrate to generate a surface comprising a first part that is more hydrophilic than a second part; (b) immersing the surface into and removing the surface from a target compound solution, wherein the target compound is deposited primarily onto the more hydrophilic part; and (c) applying and evaporating the target compound solution onto the surface to produce the pre-coated substrate.

In some aspects, the invention provides a method of producing a pre-coated substrate comprising: (a) treating a substrate to generate a surface comprising a first part that is more hydrophilic than a second part; and (b) applying and evaporating the matrix compound solution onto the surface, wherein the matrix compound is deposited primarily onto the more hydrophilic part to produce the pre-coated substrate.

In some aspects, the invention provides a method of producing a pre-coated substrate comprising: (a) treating a substrate to generate a surface comprising a first part that is more hydrophilic than a second part; and (b) applying and evaporating a matrix compound solution onto the surface, wherein the matrix compound is deposited primarily onto the more hydrophobic part to produce the pre-coated substrate.

In some aspects, the invention provides a method of producing a pre-coated substrate comprising: (a) treating a substrate to generate a surface comprising a first part that is more hydrophilic than a second part; and (b) immersing the surface into and removing the surface from a target compound solution, wherein the target compound is deposited primarily onto the more hydrophilic part to produce the pre-coated substrate.

The first part may be a contiguous area or a non-contiguous area. In some embodiments where the first part is a non-contiguous area, the first part may be defined as two or more areas. In some embodiments, there are between 2 and 100,000,000,000 non-contiguous areas on a substrate. In particular embodiments, there may be 2, 3, 4, 5, 10, 100, 1,000, 10,000, 100,000, 1,000,000, or 10,000,000 non-contiguous areas on a substrate, or any number derivable in between. These areas may have any appropriate diameter. In some embodiments, the areas have a diameter of or between 0.01 to 100,000 μm. In particular embodiments, the diameter of the areas is 00.01, 0.05, 0.1, 0.5, 1.0, 5.0, 10, 15, 20, 30, 40, 50, 60, 70, 80, 90, 100, 200, 500, 1,000, 2,000, 5,000, 10,000, 50,000, or 100,000 μm, or any number derivable in between.

The second part may be a contiguous area or a non-contiguous area. In some embodiments where the second part is a non-contiguous area, the second part may be defined as two or more areas. In some embodiments, there are between 2 and 100,000,000,000 non-contiguous areas on a substrate. In particular embodiments, there may be 2, 3, 4, 5, 10, 100, 1,000, 10,000, 100,000, 1,000,000, or 10,000,000 non-contiguous areas on a substrate, or any number derivable in between. These areas may have any appropriate diameter. In some embodiments, the areas have a diameter of or between 0.01 to 100,000 μm. In particular embodiments, the diameter of the areas is 00.01, 0.05, 0.1, 0.5, 1.0, 5.0, 10, 15, 20, 30, 40, 50, 60, 70, 80, 90, 100, 200, 500, 1,000, 2,000, 5,000, 10,000, 50,000, or 100,000 μm, or any number derivable in between.

Treating the substrate to generate a surface comprising a first part that is more hydrophilic than a second part may be done by any method known to those having skill in the art. In some embodiments, treating the substrate comprises microcontact printing. In some embodiments, the microcontact printing comprises stamping a pattern of a hydrophobic compound onto the substrate. In some embodiments, the microcontact printing further comprises: (i) depositing a first compound onto the substrate to generate the more hydrophilic first part; and (ii) depositing a more hydrophobic compound onto the parts of the substrate where the first compound is not located to generate the second part. In other embodiments, the microcontact printing further comprises: (i) depositing a first compound onto the substrate to generate the second part; and (ii) depositing a more hydrophilic compound onto the parts of the substrate where the first compound is not located to generate the more hydrophilic first part. In other embodiments, treating the substrate comprises patterning a photoresist compound onto the substrate to generate the second part. As known to those of skill in the art, a photoresist compound is typically a polymeric material that include photoactive functionalities. In some embodiments, treating the substrate comprises depositing a compound onto part of the surface of the substrate to form the more hydrophilic first part.

The substrate may be any desired substrate. In some embodiments, the substrate comprises a gold surface. In particular embodiments, the gold surface is functionalized with a hydrophilic compound. In particular embodiments, the hydrophilic compound is an organothiol containing polar or hydrogen-bonding groups. In particular embodiments, the organothiol includes one or more of the following functional groups: —OR, —CO₂R, —CONRR′, —NRR′, —NRR′R″⁺, —CO₂⁻, —PO₃H₂, —SO₃H, or —(OCH₂CH₂)ₙOR, wherein R, R′, and R″ are hydrogen (H), an alkyl or aromatic unit. In other embodiments, the substrate comprises a glass surface, a metal surface, a metal oxide surface, or an ITO-coated glass surface.

In other embodiments, treating the substrate comprises depositing a hydrophobic compound onto part of the substrate to form a partially-coated surface. In some embodiments, the hydrophobic compound is an organothiol compound. In some embodiments, the organothiol compound is an alkanethiol. In particular embodiments, the alkanethiol is fluorinated. In other embodiments, the hydrophobic compound is an organosilane compound. An organosilane may be any appropriate organosilane, including but not limited to organo chlorosilane, organo dichlorosilane, organo trichlorosilane, organo alkoxysilane, organo dialkoxysilane, and organo trialkoxysilane. In particular embodiments, the hydrophobic compound is a polymer.

The target compound may be any desired target. In some embodiments, the target compound solution is a matrix compound solution. In particular embodiments, the matrix compound solution is sinapinic acid or dihydroxybenzoic acid. The matrix compound solution may further comprising a target labeling compound or a target modifying compound, such as one that digests or chemically alters the target. An example of the latter is a solvent/vapor that contains a trialkyl amine, which forms an ionic liquid by its acid-base reaction with matrix compounds present in the spotted regions. Such methods may also include a wash step following provision of the target modifying compound, such as a water, or acid water rinse. In other embodiments, the target compound is an organic compound, an organometallic complex, a polymer, a peptide, a protein, a glycoprotein, a carbohydrate, a nucleic acid, an oligonucleotide, RNA, DNA, a steroid, a metabolite, or a drug candidate.

In further aspects, the method may further comprise placing a tissue sample on the pre-coated substrate. In still further aspects, the method may further comprise solvating the sample in a chamber containing a solvent. In some embodiments, the solvent comprises an organic solvent, water, or mixtures thereof. In particular embodiments, the organic solvent comprises methanol. In some embodiments, the solvent includes more than one organic solvent.

In still further aspects, the invention provides a pre-coated substrate prepared by the methods as disclosed herein.

In yet further aspects, the invention provides a pre-coated substrate comprising a surface comprising a first part that is more hydrophilic than a second part, wherein the first part contains a target compound. In some embodiments, the substrate comprises a gold surface. In other embodiments, the substrate comprises a glass surface, a metal surface, a metal oxide surface, or an ITO-coated glass surface. In some embodiments, the target compound solution is a matrix compound solution. The matrix compound solution may further comprising a target labeling compound or a target modifying compound, such as one that digests or chemically alters the target. An example of the latter is a solvent/vapor that contains a trialkyl amine, which forms an ionic liquid by its acid-base reaction with matrix compounds present in the spotted regions. Such methods may also include a wash step following provision of the target modifying compound, such as a water, or acid water rinse. In particular embodiments, the matrix compound solution is sinapinic acid or dihydroxybenzoic acid. In other embodiments, the target compound is an organic compound, an organometallic complex, a polymer, a peptide, a protein, a glycoprotein, a carbohydrate, a nucleic acid, an oligonucleotide, RNA, DNA, a steroid, a metabolite, or a drug candidate.

In still further aspects, the invention provides a method of preparing a sample substrate comprising: (a) obtaining a substrate comprising a uncoated surface; (b) affixing a hydrophobic substance on part of the uncoated surface to form a partially-coated surface; and (c) contacting the partially coated surface with a proton source to form a partially-activated surface. As used herein, a proton source comprises at least one compound having an ionizable proton. Typically such a compound would be an acid, for example, an inorganic acid, such as a mineral acid, or an organic acid. Bronsted acids, compounds that readily donate a hydrogen ion (H+) to other more basic compounds, are classic examples of proton sources. In some embodiments, step (c) is further defined as immersing the partially coated surface in a solution comprising a proton source. In other embodiments, step (c) is further defined as applying and evaporating a solution comprising a proton source to the partially coated surface. In some embodiments, step (c) further comprising removing any proton source that is not localized on the uncoated portions of the partially-coated surface. In other embodiments, step (c) further comprises concentrating the proton source at the uncoated portions of the partially-coated surface. In other embodiments, step (c) further comprises evaporating the solvent. In some embodiments, the method may further comprise step (d), disposing a sample on the partially activated surface.

In some embodiments, the uncoated surface comprises gold atoms. In other embodiments, the uncoated surface is a glass surface, a metal surface, a metal oxide surface, or an ITO-coated glass surface. In some embodiments, the hydrophobic substance is alkylthio_{(C6-30)} or substituted alkylthio_{(C6-30)}. In particular embodiments, the alkylthio_{(C6-30)} is hexadecanethiol. In some embodiments, the partially-coated surface comprises a monolayer of alkylthio_{(C6-30)} or substituted alkylthio_{(C6-30)} groups. In some embodiments, the proton source comprises a carboxylic acid. In particular embodiments, the carboxylic acid is sinapinic acid or dihydroxybenzoic acid.

In some embodiments, the proton source further comprises a solvent. In some embodiments, the solvent is comprises water. In other embodiments, the solvent comprises ethanol, chloroform or acetic acid. In other embodiments, the solvent comprises ethanol, chloroform and acetic acid. In particular embodiments, the solvent is about 1:1 Carnoy's solution:water. In some embodiments, the coated and uncoated portions of the partially coated surface alternate.

The embodiments in the Examples section are understood to be embodiments of the invention that are applicable to all aspects of the invention.

When used in the context of a chemical group, “hydrogen” means —H; “hydroxy” means —OH; “oxo” means ═O; “halo” means independently —F, —Cl, —Br or —I; “amino” means —NH₂ (see below for definitions of groups containing the term amino, e.g., alkylamino); “hydroxyamino” means —NHOH; “nitro” means —NO₂; imino means ═NH (see below for definitions of groups containing the term imino, e.g., alkylimino); “cyano” means —CN; “azido” means —N₃; in a monovalent context “phosphate” means —OP(O)(OH)₂ or a deprotonated form thereof; in a divalent context “phosphate” means —OP(O)(OH)O— or a deprotonated form thereof; “mercapto” means —SH; “thio” means ═S; “thioether” means —S—; “sulfonamido” means —NHS(O)₂— (see below for definitions of groups containing the term sulfonamido, e.g., alkylsulfonamido); “sulfonyl” means —S(O)₂— (see below for definitions of groups containing the term sulfonyl, e.g., alkylsulfonyl); “sulfinyl” means —S(O)— (see below for definitions of groups containing the term sulfinyl, e.g., alkylsullinyl); and “silyl” means _{—SiH}₃ (see below for definitions of group(s) containing the term silyl, e.g., alkylsilyl).

For the groups below, the following parenthetical subscripts further define the groups as follows: “(Cn)” defines the exact number (n) of carbon atoms in the group. “(C≦n)” defines the maximum number (n) of carbon atoms that can be in the group, with the minimum number of carbon atoms in such at least one, but otherwise as small as possible for the group in question, e.g., it is understood that the minimum number of carbon atoms in the group “alkenyl_{(C≦8)}” is two. For example, “alkoxy_{(C≦10)}” designates those alkoxy groups having from 1 to 10 carbon atoms (e.g., 1, 2, 3, 4, 5, 6, 7, 8, 9, or 10, or any range derivable therein (e.g., 3 to 10 carbon atoms). (Cn-n′) defines both the minimum (n) and maximum number (n′) of carbon atoms in the group. Similarly, “alkyl_{(C2-10)}” designates those alkyl groups having from 2 to 10 carbon atoms (e.g., 2, 3, 4, 5, 6, 7, 8, 9, or 10, or any range derivable therein (e.g., 3 to 10 carbon atoms)).

The term “alkyl” when used without the “substituted” modifier refers to a non-aromatic monovalent group with a saturated carbon atom as the point of attachment, a linear or branched, cyclo, cyclic or acyclic structure, no carbon-carbon double or triple bonds, and no atoms other than carbon and hydrogen. The groups, —CH₃(Me), —CH₂CH₃ (Et), —CH₂CH₂CH₃ (n-Pr), —CH(CH₃)₂ (iso-Pr), —CH(CH₂)₂ (cyclopropyl), —CH₂CH₂CH₂CH₃ (n-Bu), —CH(CH₃)CH₂CH₃ (sec-butyl), —CH₂CH(CH₃)₂ (iso-butyl), —C(CH₃)₃ (tert-butyl), —CH₂C(CH₃)₃ (neo-pentyl), cyclobutyl, cyclopentyl, cyclohexyl, and cyclohexylmethyl are non-limiting examples of alkyl groups. The term “substituted alkyl” refers to a non-aromatic monovalent group with a saturated carbon atom as the point of attachment, a linear or branched, cyclo, cyclic or acyclic structure, no carbon-carbon double or triple bonds, and at least one atom independently selected from the group consisting of N, O, F, Cl, Br, I, Si, P, and S. The following groups are non-limiting examples of substituted alkyl groups: —CH₂OH, —CH₂Cl, —CH₂Br, —CH₂SH, —CF₃, —CH₂CN, —CH₂C(O)H, —CH₂C(O)OH, —CH₂C(O)OCH₃, —CH₂C(O)NH₂, —CH₂C(O)NHCH₃, —CH₂C(O)CH₃, —CH₂OCH₃, —CH₂OCH₂CF₃, —CH₂OC(O)CH₃, —CH₂NH₂, —CH₂NHCH₃, —CH₂N(CH₃)₂, —CH₂CH₂Cl, —CH₂CH₂OH, —CH₂CF₃, —CH₂CH₂OC(O)CH₃, —CH₂CH₂NHCO₂C(CH₃)₃, and —CH₂Si(CH₃)₃.

The term “alkylthio” when used without the “substituted” modifier refers to the group —SR, in which R is an alkyl, as that term is defined above. Non-limiting examples of alkylthio groups include: —SCH₃, —SCH₂CH₃, —SCH₂CH₂CH₃, —SCH(CH₃)₂, —SCH(CH₂)₂, —S-cyclopentyl, and —S-cyclohexyl. The term “substituted alkylthio” refers to the group —SR, in which R is a substituted alkyl, as that term is defined above. For example, —SCH₂CF₃ is a substituted alkylthio group.

The use of the term “or” in the claims is used to mean “and/or” unless explicitly indicated to refer to alternatives only or the alternatives are mutually exclusive, although the disclosure supports a definition that refers to only alternatives and “and/or.”

Throughout this application, the term “about” is used to indicate that a value includes the standard deviation of error for the device or method being employed to determine the value.

Following long-standing patent law, the words “a” and “an,” when used in conjunction with the word “comprising” in the claims or specification, denotes one or more, unless specifically noted.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and also covers other unlisted steps.

The term “effective,” as that term is used in the specification and/or claims, means adequate to accomplish a desired, expected, or intended result.

The above definitions supersede any conflicting definition in any of the reference that is incorporated by reference herein. The fact that certain terms are defined, however, should not be considered as indicative that any term that is undefined is indefinite. Rather, all terms used are believed to describe the invention in terms such that one of ordinary skill can appreciate the scope and practice the present invention.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE FIGURES

The following drawings form part of the present specification and are included to further demonstrate certain aspects of the present invention. The invention may be better understood by reference to one or more of these drawings in combination with the detailed description of specific embodiments presented herein. The patent or application file contains at least one drawing executed in color. Copies of this patent or patent application publication with color drawings will be provided by the Office upon request and payment of the necessary fee.

FIG. 1—Array of matrix compound (sinapinic acid) formed spontaneously upon emersion from solution. The surface was patterned using microcontact printing methods to expose 100 micron diameter hydrophilic regions that were separated from each other by a hydrophobic surface region.

FIG. 2—Array of matrix compound (sinapinic acid) formed spontaneously after the evaporation of a solution pipetted onto the support surface. The surface was patterned using microcontact printing methods to expose 160 micron diameter hydrophilic regions that were separated from each other by a hydrophobic surface region, and then underwent an emersion from solution step as in FIG. 1.

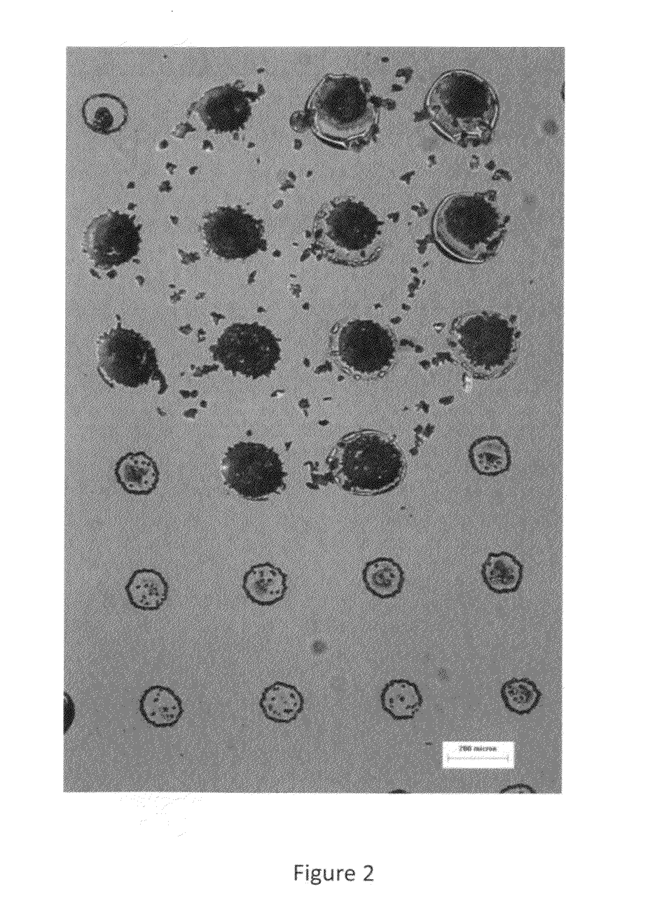

FIG. 3—MALDI mass spectral data obtained from a tissue sample placed onto top of a pre-coated slide containing matrix compound in 500 micron diameter spots. (Top) Tissue sample placed on top of pre-coated matrix slide. No post processing. (Middle) Tissue sample placed on top of pre-coated matrix slide and then exposed to water vapor. (Bottom) Tissue sample placed on top of pre-coated matrix slide and then exposed to a methanol/water vapor mixture. During this process, solvent condenses at the location of the matrix crystals and assists in contact between the matrix compound and the local contents of the tissue as seen by the increased number of signals in the mass spec.

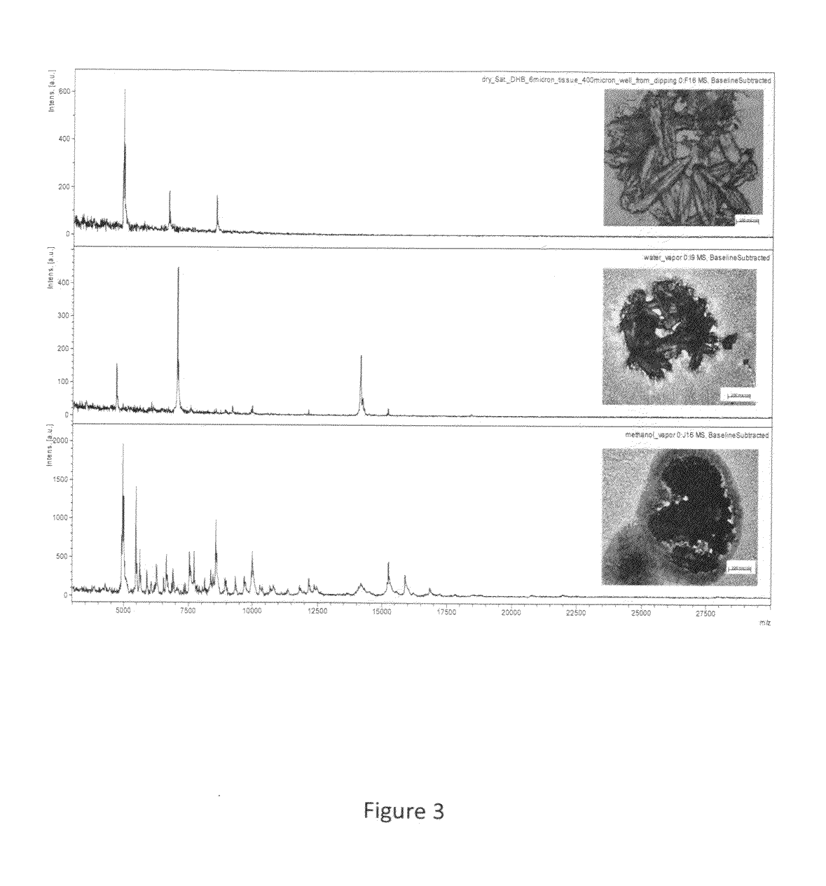

FIGS. 4A-G—MALDI imaging of a mouse brain tissue placed on top of a pre-coated slide containing matrix compound patterned in a array of 100 micron diameter spots and processed as in FIG. 3. FIG. 4A: tissue in contact with patterned matrix array. FIGS. 4B-G: Intensity maps from MALDI imaging for specific molecular weights on the tissue sample.

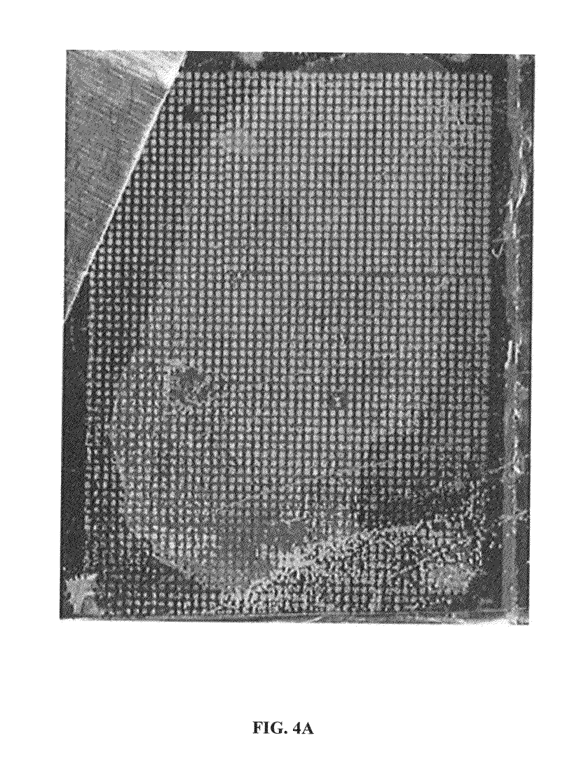

FIG. 5—Microcontact printing with PDMS stamp on gold surface

FIG. 6—Midpoint: droplets of matrix solution on gold coated glass slide

FIG. 7—Matrix deposition on microarray

FIG. 8—Mounting a tissue section onto the microarray of matrix crystals

FIGS. 9A-B—Processing of mounted surface. DHB: Slide was put in a sealed chamber with 200 μL of methanol under room temperature for 2 min.

FIG. 10—Protein region from a 200 μm sinapinic acid microarray spot mounted over with a 6 μm thick rat brain section.

FIG. 11—Lipid region from a 100 μm sinapinic acid microarray spot mounted over with a 5 μm thick mouse brain section.

FIGS. 12A-F—MALDI imaging of lipids from a 100 μm sinapinic acid microarray spot mounted over with a 5 μm thick mouse brain section.

FIG. 13—Sample preparation using a target pre-coated with microarray of matrix. The figure illustrates examples where the order of the steps to transform the matrix into droplets by a vapor phase treatment and to attach the tissue section are switched. The figure also illustrates the use of a rinse step prior to analysis. Pink: sinapinic acid, Green: sinapinic acid/DIEA/H₂O.

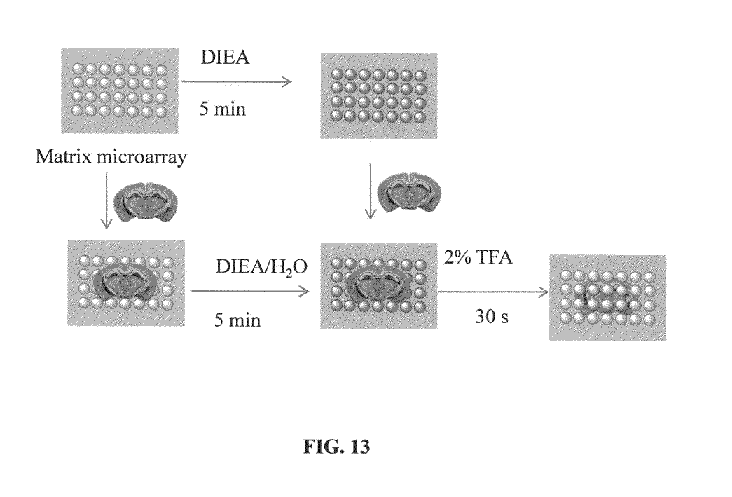

FIG. 14—Microscope pictures of the matrix microarray at different stages of sample preparation. The matrix microarrays crystals (SA), after treatment with a vapor of DIEA (SA DIEA), after addition of a tissue section, and finally after a TFA/water rinse and drying.

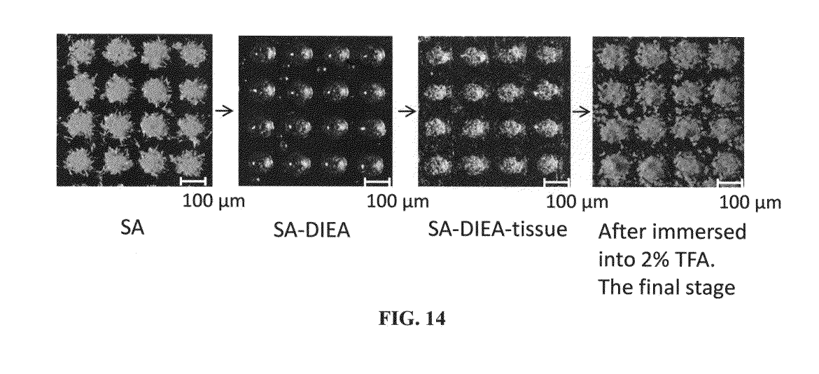

FIG. 15—Ion images of a mouse brain section using target pre-coated with a microarray of matrix and undergoing the process steps outlined by FIG. 14.

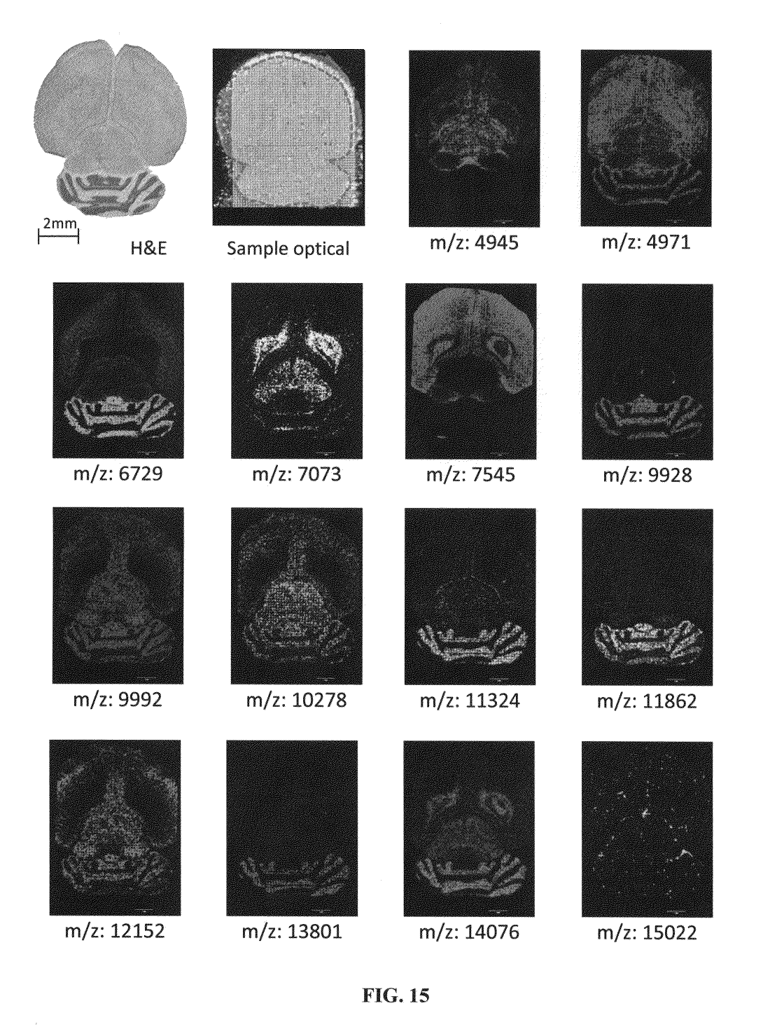

### DESCRIPTION OF THE ILLUSTRATIVE EMBODIMENTS

Sample preparation can be a tedious and time consuming task. For example, MALDI imaging of tissue samples can require the tedious process of hand or robotically spotting solutions containing chemical species referred to as “matrix” onto a tissue sample prior its mass spectral analysis.

An approach is presented which combines the advantage of high density matrix application for imaging and ease of sample preparation while maintaining the ability to analyze a wide variety of analytes including proteins and peptides. This new methodology can potentially realize high throughput, high sensitivity, and high resolution MALDI imaging. This approach may also be useful in any situation where regiospecifically depositing or patterning material on a surface would be needed.

### A. Preparation of the Samples

An alternative route has been developed whereby substrates are pre-coated with target compounds as a way to both accelerate sample analysis times as well as afford superior control in depositing the target compounds. The process consists of multiple steps that rely on a selectivity in surface wettability during each process step to provide registry between steps and allow parallel rather than serial processing for spotted regions.

1. Generation of a Pattern of Hydrophobic and Hydrophillic Regions

In some aspects, the methods of the present invention involving treating a substrate to generate a surface comprising a first part that is more hydrophilic than a second part. This exposes localized regions that are more hydrophilic than the surface that surrounds it.

When used in the context of a surface, the term “hydrophilic” means that the surface is more easily wetted by the deposited liquid, such as the target compound solution, in that the liquid will be more likely retained on the surface than on a more hydrophobic surface.

When used in the context of a surface, the term “hydrophobic” means that the surface is less easily wetted by the deposited liquid, in that a liquid will be less likely retained on the surface than on a more hydrophilic surface.

In some embodiments, the substrate would have an outer purposely more hydrophobic area and inner unfunctionalized regions that would be hydrophilic by comparison. This treatment may be known as patterning and is known to those of skill in the art. Examples of methods that may be used include microcontact printing, inkjet printing, patterning of photoresist (usually polymeric material that include photoactive functionalities), or other similar methods.

In some embodiments, the patterned surface may be generated using microcontact printing techniques. Microcontact printing (or μCP) uses the relief patterns on a polydimethylsiloxane (PDMS) stamp to form patterns of inks, such as a hydrophobic compound, on the surface of a substrate through conformal contact. For example, microcontact printing may be used to regioselectively direct the attachment of an organothiol compound (n-hexadecanethiol) onto a gold coated surface. In other embodiments, the microcontact printing may be used to direct the attachment of an organosilane onto a metal oxide or glass surface. In some embodiments, the patterned surface may be generated by depositing the more hydrophobic compound onto the substrate and then backfilling the unprinted regions with a more hydrophillic compound. In other embodiments, the patterned surface may be generated by depositing the more hydrophilic compound onto the substrate and then backfilling the unprinted regions with a more hydrophobic compound.

Making a surface rough is also known to make hydrophobic surfaces more hydrophobic and make hydrophilic surfaces more hydrophobic through Wenzel's relationship. A TiO₂ mask may be used to direct spatially where oxidation to clean the surface occurs as a way to generate a patterned surface. Similarly, this patterned surface may be used to direct where a target compound would deposit on a surface. Relatedly, it has been shown that depositing an alkanethiol over a complete surface followed by selective UV irradiation to some regions will result in loss of the thiol from those locations rendering them more hydrophilic and keeping the other regions hydrophobic.

In some embodiments, the substrate is a gold substrate. Gold, when clean, is hydrophilic. However, it will tend to get dirty and become less hydrophilic with time. Thiols have been used since the mid 1980s as way to modify the gold surface purposely with a self-assembled monolayer (SAM), where functional groups present in the thiols can make the SAM take on a particular hydrophilicity or hydrophobicity. The surface of gold may be made hydrophobic by using a perfluoro-alkanethiol. Notsu et al. (2005). Alternatively, an oxidation process may be used to clean the gold and make it hydrophilic.

The more hydrophilic first part may be contiguous or not continguous. In some embodiments where the first part is a non-contiguous area, the first part may be defined as two or more areas. In some embodiments, there are between 2 and 100,000,000,000 non-contiguous areas on a substrate. In particular embodiments, there may be 2, 3, 4, 5, 10, 100, 1,000, 10,000, 100,000, 1,000,000, or 10,000,000 non-contiguous areas on a substrate, or any number derivable in between.

These areas may have any appropriate diameter. In some embodiments, the areas have a diameter of or between 0.01 to 100,000 μm. In particular embodiments, the diameter of the areas is 00.01, 0.05, 0.1, 0.5, 1.0, 5.0, 10, 15, 20, 30, 40, 50, 60, 70, 80, 90, 100, 200, 500, 1,000, 2,000, 5,000, 10,000, 50,000, or 100,000 μm, or any number derivable in between.

The number of areas on the substrate may correlate to the size of the areas. For example, a substrate having 100 μm diameter spots that are separated from each other by 150 μm spot-to-spot distance would have about 40 non-contiguous areas per mm² of surface area, or about 10,000 non-contiguous areas in total. Another example would be a substrate having about 10,000,000 non-contiguous areas that are approximately 1 μm in diameter. A further example would be a substrate having about 1,000,000,000 non-contiguous areas that are approximately 0.1 μm in diameter. These examples are not limiting.

2. Generation of a Pattern of Target Compounds

After patterning the substrate, the surface of the substrate may be immersed into a target compound solution, wherein the target compound is deposited primarily onto the more hydrophilic part. After emersion of the substrate, the liquid retreats from the surface leaving behind microdroplets of solution in the hydrophilic patches on the substrate surface. Solvent evaporation results in the deposition of target compound on these hydrophilic areas. It appears that selective dewetting by a retreating solution is used to generate the pattern.

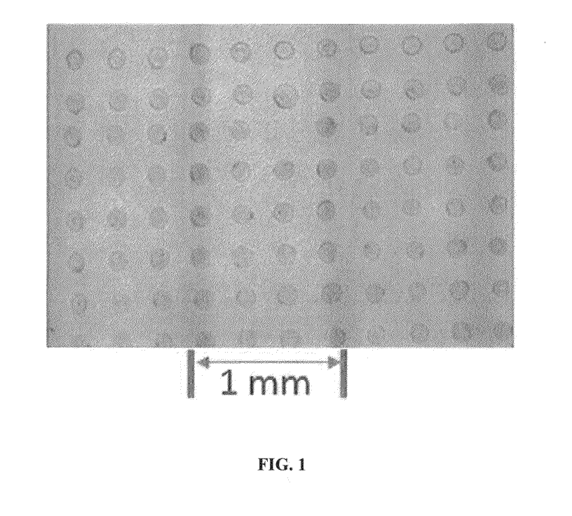

The target compound solution may be any solution containing a target compound that is appropriate for the desired results. In some aspects, the target solution may be a matrix solution, such as sinapinic acid or dihydroxybenzoic acid. Parameters of target concentration, solvent, spot size, emersion conditions define the amount of target material deposited on the substrate surface. In one example, the substrate has more hydrophilic regions having using spot diameters of ˜100 microns and solutions of matrix compounds in nonaqueous solvents (FIG. 1).

Either after or instead of the emersion process discussed above, a liquid film comprising a target compound may be spread on the surface. In some embodiments, the liquid film is spread on a substrate surface that has only been patterned to expose localized hydrophilic regions within a hydrophobic surface. In another embodiment, the liquid film is spread on a substrate surface that has been previously emersed from a target solution as described above. During evaporation of the solvent, crystals grow preferentially in the patterned regions and deposition can occur prior to the solvent retreating from the substrate. Deposition of the target compound appears to occur by a process that involves directed nucleation. More particularly, one surface, such as the more hydrophobic surface, avoids having the matrix deposit on it. Presumably this is due to being a non-adsorbing surface, which is typically a low energy one, which usually exhibit hydrophobic properties. In other solvents, the hydrophobic surface may provide a more favorable region for directed nucleation and deposition to occur. In one example, the substrate has more hydrophilic regions having spot diameters of ˜160 microns. The process may be useful for depositing other chemical species as well as dispersible solids.

3. Combining a Pre-Coated Substrate with a Sample

A tissue sample may be placed onto this patterned pre-coated substrate. Incubation in contact with solvent vapor results in the formation of liquid drops that preferentially condense and form on the support in the regions defined by the target compound crystal deposition. Solvent parameters are selected (as are temperature and other processing conditions) to control rates and levels of condensation. Upon drying, the sample is ready for use, such as for MALDI imaging. The solvent micro-droplets that form allow contact to occur between a local section of the tissue and matrix compound by their mutual dissolution.

For MALDI imaging, this condensed liquid film assists in extracting lipids, peptides, etc., from the tissue. Particularly good success for MALDI has been achieved when the condensing liquid is or includes methanol. This process has been demonstrated using spot diameters of 500 microns.

### B. Applications for the Prepared Sample

Samples may be prepared for many different types of applications where regiospecifically depositing or patterning material on a surface and having the material become selectively become solvated would be useful.

For example, the disclosed methods may be useful in tissue sample preparation for MALDI imaging. These methods may also be useful to engineer surfaces that concentrate or desalt, depositing reagents for interacting with samples such as tissue or liquid samples deposited onto the spots of the engineered surfaces, liquid or gas streams that contact or flow over the surface or the like. Similarly, these compounds may also be useful for other areas of chemical analysis, drug discovery, high throughput screening, or the construction of an array of a compound or of mixtures in isolated areas.

1. MALDI Imaging

Matrix-assisted laser desorption/ionization (MALDI) is a soft ionization technique used in mass spectrometry, allowing the analysis of biomolecules (biopolymers such as proteins, peptides and sugars) and large organic molecules (such as polymers, dendrimers and other macromolecules), which tend to be fragile and fragment when ionized by more conventional ionization methods. See U.S. Pat. No. 5,808,300. It is most similar in character to electrospray ionization both in relative softness and the ions produced (although it causes many fewer multiply charged ions). The ionization is triggered by a laser beam (e.g., a nitrogen laser). A matrix is used to protect the biomolecule from being destroyed by direct laser beam and to facilitate vaporization and ionization.

Manual spraying of matrix solution on top of a tissue section, for example for MALDI imaging, is a low cost technique that gives good sensitivity but poor reproducibility. For example, homogeneous high density coatings are difficult to achieve especially for peptides and proteins unless expensive robotics are employed. Automatic spotters have excellent reproducibility but are expensive and require labor intensive maintenance. Pre-coating the MALDI target with matrices by nebulized spray or sublimation, conversely, can give great spatial resolution (˜5 μm) but generally can only ionize species with m/z less than 2000. This mass range primarily contains signals from lipids or phospholipids but does not give high quality protein spectra.

The disclosed method solve many problems associated with MALDI imaging. First, the disclosed methods allow 2D spatial control over the maximum size, location, and spacing of matrix crystals (or other compounds/species) on a support. These methods also remove the need for having and maintaining expensive spotting instruments from MALDI tissue analyses that hamper many laboratories. Further, these methods also remove the time-consuming need for depositing matrix onto tissue samples. Sample turnaround times are shortened from 4 to 8 hours to less than 30 minutes by moving the traditional post-processing steps of matrix deposition into an approach where patterns occur spontaneously and precede tissue sample handling. Further, the disclosed methods allow controlled amounts of matrix compound to interact with small local and non-overlapping regions of the tissue in a rapid and parallel way. Even further, these methods allow one the ability to achieve finer resolution and high density localizations than possible by robotic spotting techniques. Processing is done in a more time efficient parallel approach in contrast with the serial approach for robotic spotting meaning that comparisons in improvements in processing times increase as finer resolution systems are compared.

### C. EXAMPLES

The following examples are included to demonstrate particular embodiments of the invention. It should be appreciated by those of skill in the art that the techniques disclosed in the examples which follow represent techniques discovered by the inventor to function well in the practice of the invention. However, those of skill in the art should, in light of the present disclosure, appreciate that many changes can be made in the specific embodiments which are disclosed and still obtain a like or similar result without departing from the spirit and scope of the invention.

### Example 1

The inventors used microcontact printing to “stamp” an alkanethiol onto a gold surface for generating an outer purposely hydrophobic area and inner unfunctionalized regions that would be hydrophilic by comparison. This patterned surface was dipped into a matrix compound solution and withdrawn to produce a pattern of solution droplets on the substrate. The use of organic solvents was a departure from literature reports, where organic solvents could be viewed as less likely to be successful due to their lower surface tensions. Patterns of matrix compounds were successfully generated and MALDI spectra from patterned matrix compounds were obtained when the matrix compounds contained test samples of lipids or proteins. The pre-coated slides were not useful in producing MALDI spectra when a tissue sample was placed above them.

### Methods

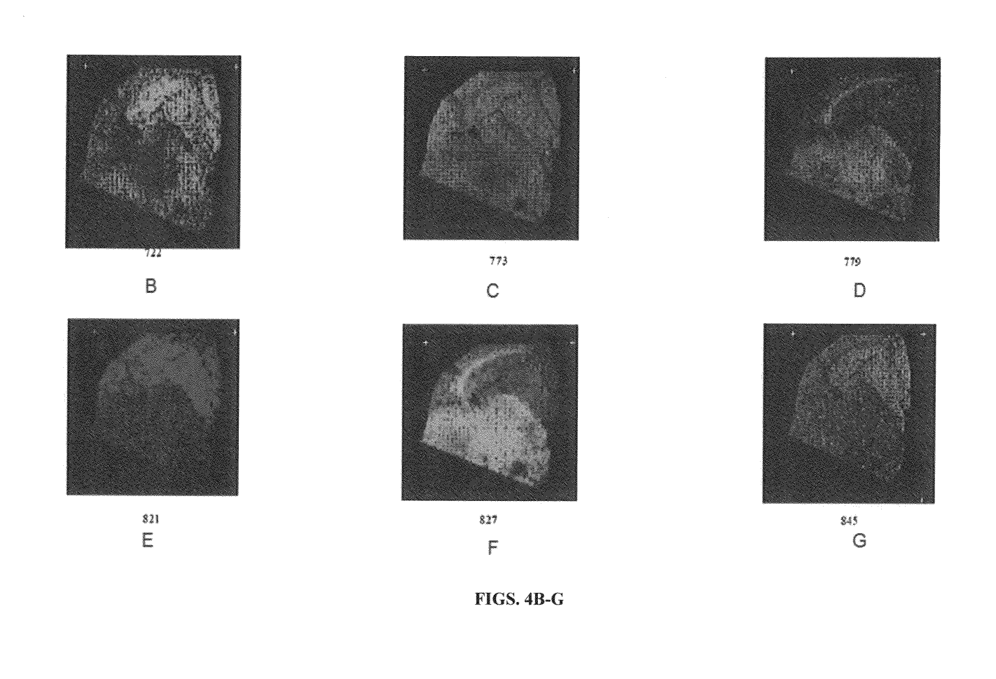

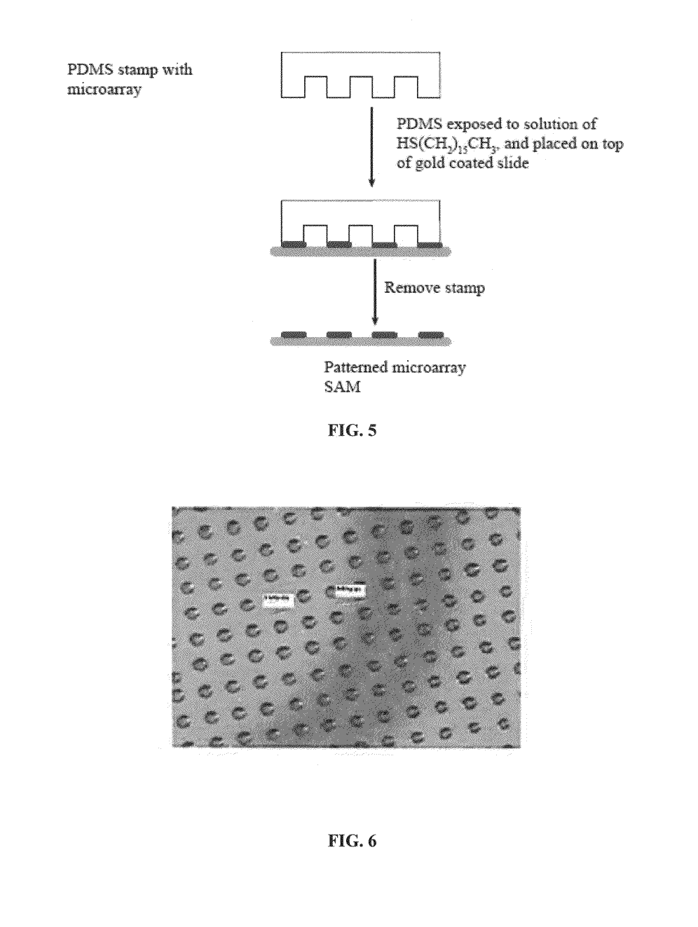

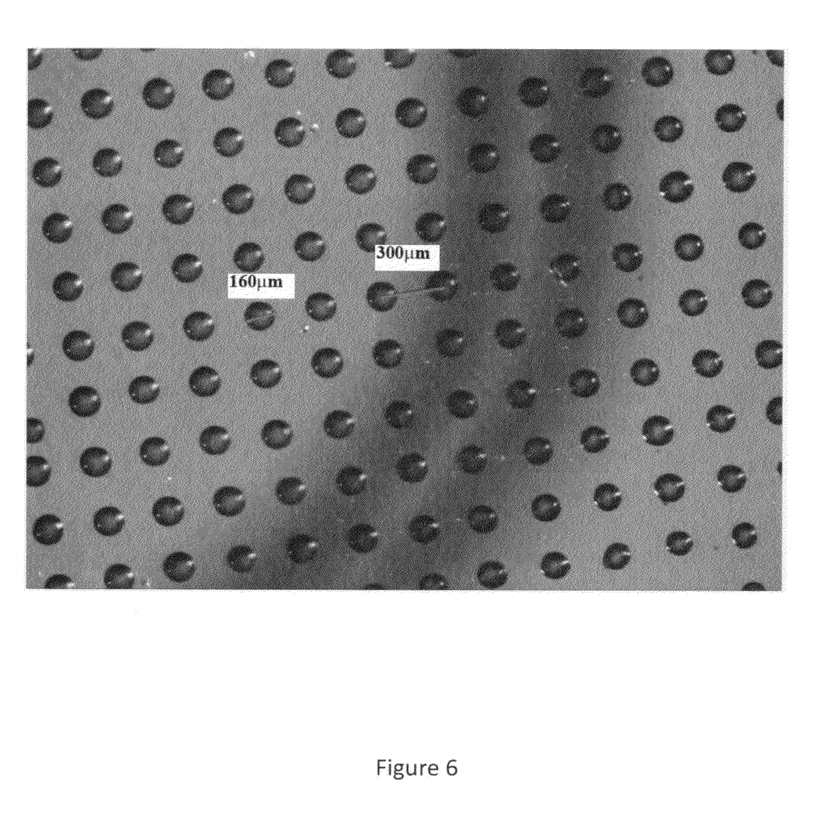

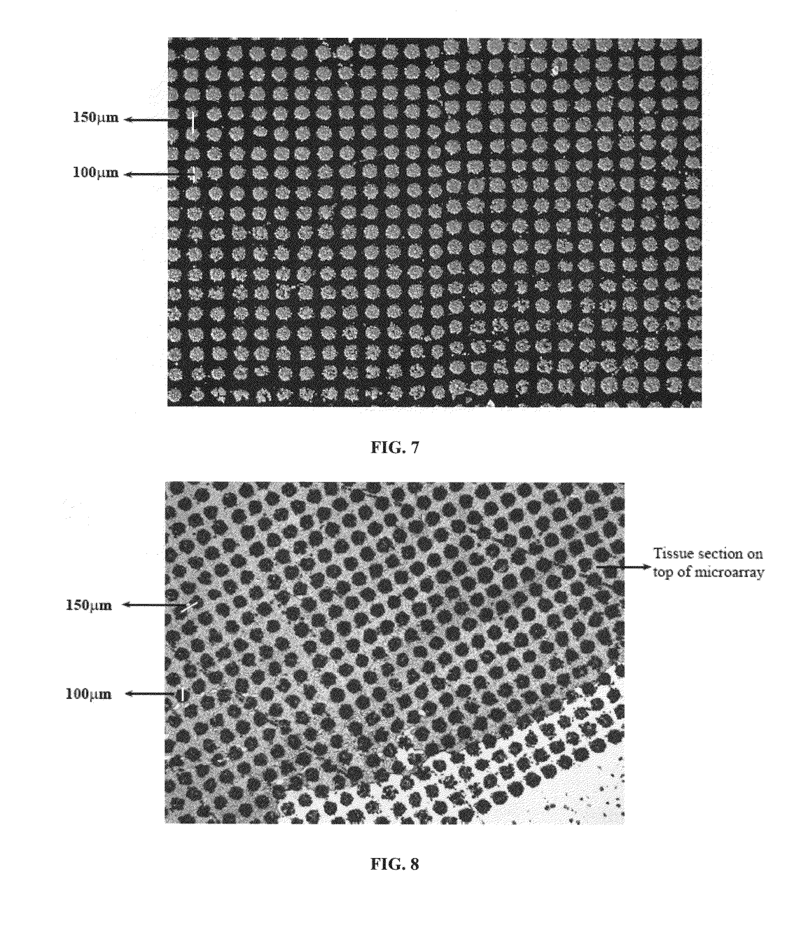

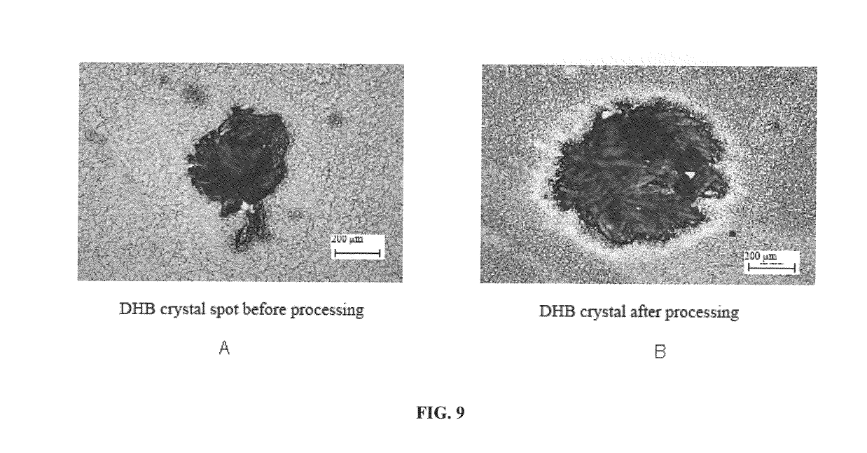

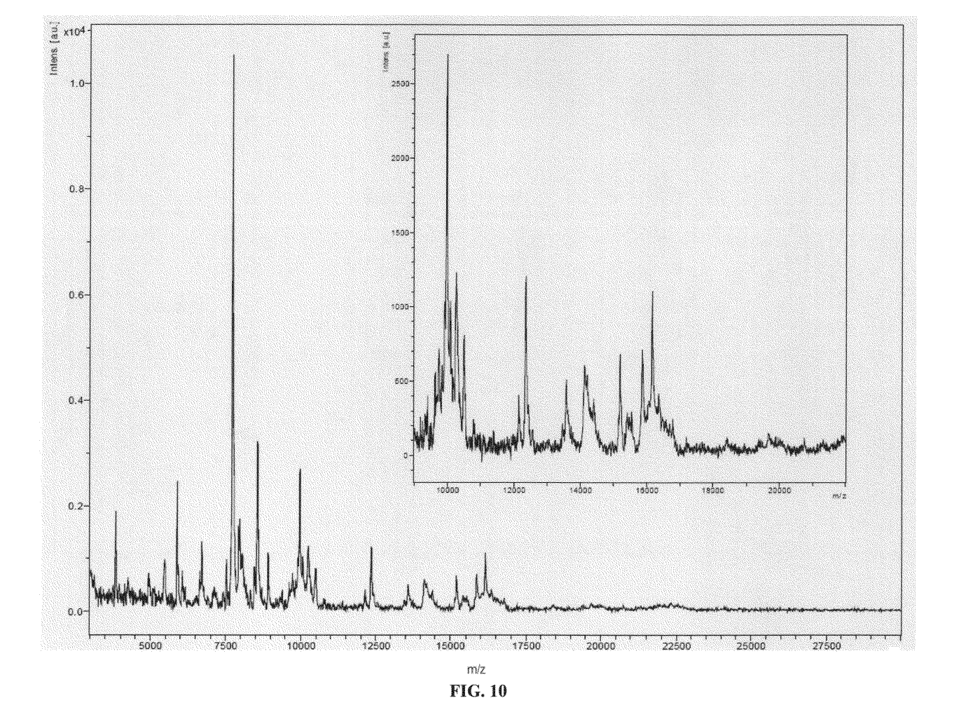

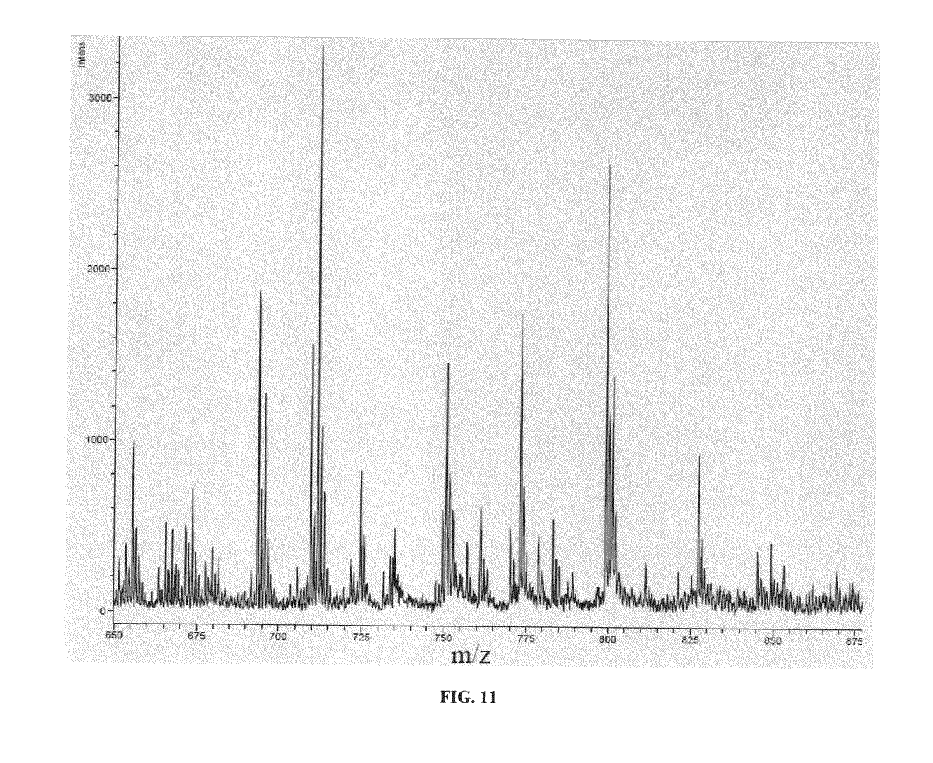

A microarray featured surface was constructed by contact printing a gold coated glass slide with a polydimethylsiloxane (PDMS) stamp hosting an array of microwells (diameter ranges from 1 to 500 μm) “inked” with hexadecanethiol. The printing resulted in a slide with a hydrophilic microarray (gold surface) surrounded by a hydrophobic surface (hexadecanethiol monolayer) (FIG. 5). This slide was immersed into a sinapinic acid (Sa) solution (20 mg Sa in 1:1 of Canoy's solution:water (Carnoy's solution is made of 6:3:1 of ethanol:chloroform:acetic acid)) (FIG. 6), and an array of matrix crystal was obtained on the slide surface after solvent evaporation (FIG. 7). A 5 μm thin rat brain section was thaw mounted on the microarray (FIG. 8). The slide was then put inside a humidity chamber (Corning Hybridization Chamber) with 200 μL of water and 40 μL of methanol and left at 90° C. for 8 min (FIGS. 9A and B). Mass spectometry profiling and imaging experiments were conducted. Sinapinic acid: slide was putin a sealed chamber with 200 μL of water and 40 μL of methanol under 90° C. for 10 min. (Crystal shows no obvious change before and after). DHB: Slide was put in a sealed chamber with 200 μL of methanol under room temperature for 2 min. Mass spectometry profiling an imaging experiments were conducted (FIGS. 10 and 11).

### Conclusion

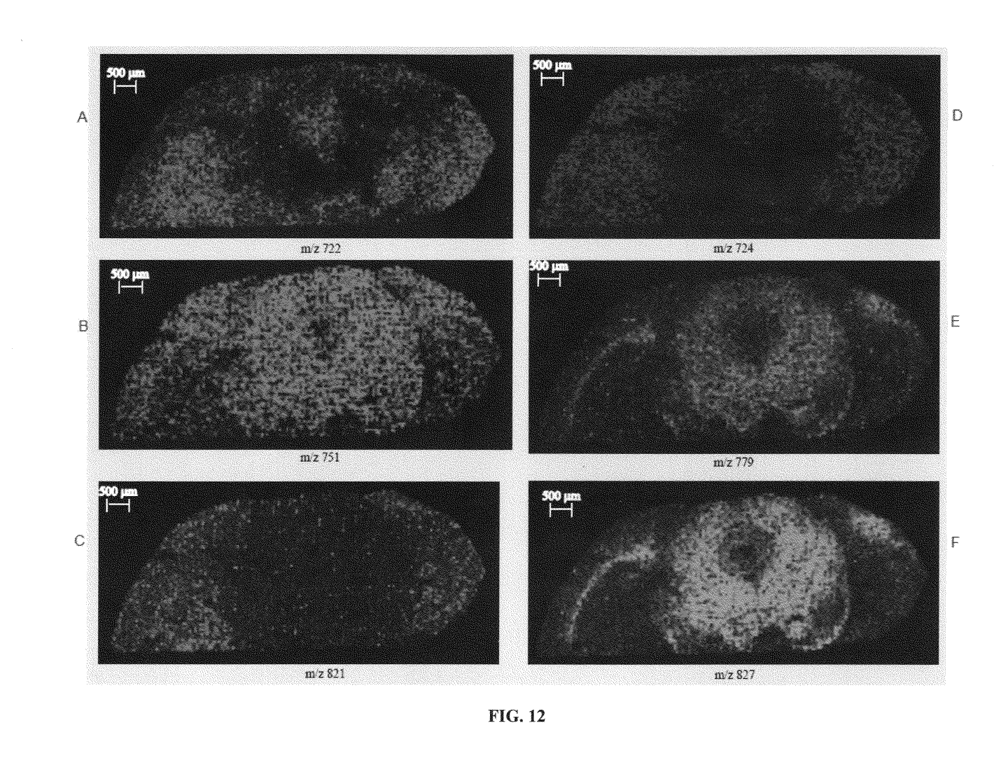

A microarray surface suitable for MALDI IMS was successfully prepared and ion signal ranging from 500 to 20000 m/z were detected using this approach (FIGS. 12A-F). With this precoating, the sample preparation is high throughput and as one stamp can be used multiple times, this method is also cost effective. These methods may be further modified to optimize the extraction efficiency by different solvent, temperature, and duration of processing, hence to increase the sensitivity.

### Example 2

The procedure was adapted so that after emersion of the slide, the slides were then transferred to a humidity chamber to avoid solvent evaporation from the matrix compound solution droplets and then frozen. Tissue samples were then placed on top of these frozen precoated sample yielding some signals from the tissue (mostly from lipids, not from proteins (higher molecular weight)). In general, signals were very weak and signals from species included with the matrix solution seemed to be blocked by the overlaying tissue.

### Methods

The fabrication process of a microarray featuring high density matrix spots involved contact printing an array of 300 micron diameter spots onto a Au coated MALDI target using a patterned polydimethylsiloxane (PDMS) stamp “inked” with hexadecanethiol. This plate was emersed from a DHB (2,5-dihydroxybenzoic acid) solution (15 mg of DHB in 1 mL of acetonitrile/H2O (1:1) with 0.1% TFA), immediately placed into a humidity chamber that was then placed in a −80° C. freezer. For IMS analysis, a 4 micron thin rat brain section was thaw mounted onto the frozen target plate. The plate was then allowed to dry at room temperature and was subsequently analyzed by MALDI MS in both the profiling and imaging mode.

### Data

The contact printing formed hydrophilic areas on the gold surface surrounded by a hydrophobic surface (hexdecanethiol area). On microscopic examination of the spotted array plate, the matrix coating process retained the DHB solution as droplets on the gold surface and the dry diameter of the matrix spot was estimated to be about 60 microns with 300 microns spacing center-to-center. When matrix compound solutions that contained lipid and peptide standards were deposited on these microcontact printed substrates, intense signals were observed; e.g., lipids at m/z 496 (1-Palmitoyl-sn-glycero-3-phosphocholine), and peptides at m/z 556.6 (Leucine Enkephalin), m/z 1047.2 (Angiotensin II human), m/z 1570.67 ([Glu1]-Fibrinopeptide B human), and m/z 3496.9 (Insulin Chain B). For tissue imaging experiments, signals for lipids (from m/z 600 to 1200) were detected at locations where the tissue contacted the matrix compound spots but not outside these areas. The spectra were comparable to that obtained from routine profiling with manual spotting on the surface of the tissue.

Overall, the results show that the strategy of pre-coating targets with matrix solution in microarrays can be used successfully without delocalization of the analytes. With these microarray targets, spot-to-spot matrix homogeneity is achieved while at the same time drastically reducing sample preparation time. These arrays can be constructed with much smaller spots and at higher densities for imaging experiments.

### Example 3

The inventors took the samples that had a thin pattern of dried matrix crystals on their surface from Examples 1, pipetted matrix compound solution onto this surface and subject it to partial air drying. Surprisingly, matrix crystals formed predominately in the regions where the first films of matrix had been cast. The resulting spots of matrix crystals seemed to be sufficiently thick that they generated cracks in an overlain tissue that allowed more signals to be pass from the underlying matrix. Signals produced from species in the tissue sample were weak and not reproducible.

### Example 4

The inventors then considered the possibility of using a vapor stream as a way to enhance interaction between the thicker films of deposited matrix on the pre-coated slides and the overlain tissue. A slide having a more hydrophilic region and a more hydrophobic region was immersed into a matrix compound solution and allowed to dry. A matrix compound solution was then pipetted on the surface of the slide and allowed to evaporate to produce a pre-coated slide.

A tissue sample was placed atop the pre-coated slide and the slide and sample were placed into a chamber with methanol and water to allow extraction. Other solvents would be suitable as well. By this, it was possible to demonstrate the surface selective condensation of vapors into the regions where the matrix spots were under the tissue. Here, the use of methanol (or methanol and water) as well as other organic compounds proved to greatly assist getting the matrix and tissue contents to contact, which was surprising and unexpected. Remarkably, the condensation could be controlled easily to generate separated droplets within the tissue defined by the regions where the matrix was placed.

### Example 5

The inventors then used more concentrated matrix solutions in the method disclosed in Example 1, which proved for more soluble matrix compounds, such as dihydroxybenzoic acid, that a sufficiently thick layer of matrix could be deposited so that the step of pipetting/drying of a solution that completely covered the slide surface in Example 3 could be skipped. Thus, a patterned surface was immersed in a concentrated solution containing a matrix compound and dried to produce a pre-coated slide. A tissue sample was placed atop the pre-coated slide and the slide and sample were placed into a chamber with methanol and water to allow extraction. Other solvents would be suitable as well.

### Example 6

The inventors then employed the method of Example 4 without immersing the slide in a matrix compound solution. Instead, a matrix solution was pipetted to fully cover the surface of a patterned slide having a more hydrophilic region and a more hydrophobic region and allowed to begin evaporating. This resulted in matrix compound deposition in the hydrophilic areas. After at least partial drying, a tissue sample was placed on the surface, and the solvation step mentioned a number of times above was used.

### Example 7

The inventors also employed the methods detailed above to deposit the matrix compound in the hydrophilic areas. After drying, a tissue sample was placed on the surface. The solvation step mentioned a number of times above was replaced by one that provided a vapor of water and diisopropyl ethyl amine to convert the deposited matrix into droplets of an ionic liquid that assisted in analytic extraction. The tissue sample was later rinsed with acidic water (typically a dilute solution of trifluoroacetic acid) to remove the amine as a way to improve detection and then allowed to dry.

### Example 8

The inventors also employed the method of Example 7 except that the process order was changed. Here, after the matrix compound had been deposited in the hydrophilic areas, the sample was exposed to a solvation step using vapors of water and diisopropyl ethyl amine to convert the deposited matrix into droplets of an ionic liquid. Afterward, a tissue section was then placed onto the slide containing the ionic liquid droplets, and the sample was incubated to allow analyte extraction prior to the sample undergoing the rinse with acidic water and drying as performed in Example 7. This process assisted in adhering the applied tissue section to the support due to the presence of the liquid droplets.

All of the compositions and/or methods disclosed and claimed herein can be made and executed without undue experimentation in light of the present disclosure. While the compositions and methods of this invention have been described in terms of some embodiments, it will be apparent to those of skill in the art that variations may be applied to the compositions and methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### V. REFERENCES

The following references, to the extent that they provide exemplary procedural or other details supplementary to those set forth herein, are specifically incorporated herein by reference.
U.S. Pat. No. 5,808,300
Notsu et al., J. Materials Chem., 15:1523-1527, 2005.

1. A method of producing a pre-coated substrate comprising:
(a) treating a substrate to generate a surface comprising a first part that is more hydrophilic than a second part;
(b) immersing the surface into and removing the surface from a target compound solution, wherein the target compound is deposited primarily onto the more hydrophilic part; and
(c) applying and evaporating the target compound solution onto the surface to produce the pre-coated substrate.

2. The method of claim 1, wherein the first part is a contiguous area.

3. The method of claim 1, wherein the first part is a non-contiguous area.

4. The method of claim 3, wherein the first part is further defined as areas having a diameter between 0.01 to 100,000 μm.

5. The method of claim 3, wherein first part comprises between 2 and 100,000,000,000 non-contiguous areas.

6. The method of claim 1, wherein the second part is a contiguous area.

7. The method of claim 1, wherein the second part is a non-contiguous area.

8. The method of claim 7, wherein the second part is further defined as areas having a diameter between 0.01 to 100,000 μm.

9. The method of claim 7, wherein the second part comprises between 2 and 100,000,000,000 non-contiguous areas.

10. The method of claim 1, wherein treating the substrate comprises microcontact printing.

11. The method of claim 10, wherein the microcontact printing comprises stamping a pattern of a hydrophobic compound onto the substrate.

12. The method of claim 10, wherein the microcontact printing further comprises:
(i) depositing a first compound onto the substrate to generate the more hydrophilic first part; and
(ii) depositing a more hydrophobic compound onto the parts of the substrate where the first compound is not located to generate the second part.

13. The method of claim 10, wherein the microcontact printing further comprises:
(i) depositing a first compound onto the substrate to generate the second part; and
(ii) depositing a more hydrophilic compound onto the parts of the substrate where the first compound is not located to generate the more hydrophilic first part.

14. The method of claim 1, wherein treating the substrate comprises patterning a photoresist compound onto the substrate to generate the second part.

15. The method of claim 1, wherein treating the substrate comprises depositing a compound onto part of the surface of the substrate to form the more hydrophilic first part.

16. The method of claim 1, wherein the substrate comprises a gold surface.

17. The method of claim 16, wherein the gold surface is functionalized with a hydrophilic compound.

18. The method of claim 17, wherein the hydrophilic compound is an organothiol containing polar or hydrogen-bonding groups.

19. The method of claim 18, wherein the organothiol includes one or more of the following functional groups: —OR, —CO₂R, —CONRR′, —NRR′, —NRR′R″⁺, —CO₂⁻, —PO₃H₂, —SO₃H, or —(OCH₂CH₂)ₙOR, wherein R, R′, and R″ are hydrogen (H), an alkyl or aromatic unit.

20. The method of claim 1, wherein the substrate comprises a glass surface, a metal surface, a metal oxide surface, or an ITO-coated glass surface.

21. The method of claim 1, wherein treating the substrate comprises depositing a hydrophobic compound onto part of the substrate to form a partially-coated surface.

22. The method of claim 10, wherein the hydrophobic compound is an organothiol compound.

23. The method of claim 22, wherein the organothiol compound is an alkanethiol.

24. The method of claim 23, wherein the alkanethiol is fluorinated.

25. The method of claim 10, wherein the hydrophobic compound is an organosilane compound.

26. The method of claim 10, wherein the hydrophobic compound is a polymer.

27. The method of claim 1, wherein the target compound solution is a matrix compound solution.

28. The method of claim 27, wherein the matrix compound solution is sinapinic acid or dihydroxybenzoic acid.

29. The method of claim 1, wherein the target compound is an organic compound, an organometallic complex, a polymer, a peptide, a protein, a glycoprotein, a carbohydrate, a nucleic acid, an oligonucleotide, RNA, DNA, a steroid, a metabolite, or a drug candidate.

30. The method of claim 1, further comprising:
(d) placing a tissue sample on the pre-coated substrate.

31. The method of claim 30, further comprising:
(e) solvating the sample in a chamber containing a solvent.

32. The method of claim 31, wherein the solvent comprises an organic solvent, water, or mixtures thereof.

33. The method of claim 32, wherein the organic solvent comprises methanol.

34. A pre-coated substrate prepared by the method of claim 1.

35. A method of producing a pre-coated substrate comprising:
(a) treating a substrate to generate a surface comprising a first part that is more hydrophilic than a second part; and
(b) applying and evaporating a matrix compound solution onto the surface, wherein the matrix compound is deposited primarily onto the more hydrophilic part to produce the pre-coated substrate.

36-45. (canceled)

46. The method of claim 44, wherein the microcontact printing further comprises:
(i) depositing a first compound onto the substrate to generate the more hydrophilic first part; and
(ii) depositing a more hydrophobic compound onto the parts of the substrate where the first compound is not located to generate the second part.

47. The method of claim 44, wherein the microcontact printing further comprises:
(i) depositing a first compound onto the substrate to generate the second part; and
(ii) depositing a more hydrophilic compound onto the parts of the substrate where the first compound is not located to generate the more hydrophilic first part.

48-60. (canceled)

61. The method of claim 35, wherein the matrix compound solution comprises a target labeling compound or an agent that digests a target.

62. (canceled)

63. (canceled)

64. A method of producing a pre-coated substrate comprising:
(a) treating a substrate to generate a surface comprising a first part that is more hydrophilic than a second part; and
(b) applying and evaporating the matrix compound solution onto the surface, wherein the matrix compound is deposited primarily onto the more hydrophobic part to produce the pre-coated substrate.

65. The method of claim 35, further comprising:
(c) placing a tissue sample on the pre-coated substrate.

66. The method of claim 65, further comprising:
(d) solvating the sample in a chamber containing a solvent.

67. (canceled)

68. (canceled)

69. A pre-coated substrate prepared by the method of claim 35.

70. A method of producing a pre-coated substrate comprising:
(a) treating a substrate to generate a surface comprising a first part that is more hydrophilic than a second part; and
(b) immersing the surface into and removing the surface from a target compound solution, wherein the target compound is deposited primarily onto the more hydrophilic part to produce the pre-coated substrate.

71-80. (canceled)

81. The method of claim 79, wherein the microcontact printing further comprises:
(i) depositing a first compound onto the substrate to generate the more hydrophilic first part; and
(ii) depositing a more hydrophobic compound onto the parts of the substrate where the first compound is not located to generate the second part.

82. The method of claim 79, wherein the microcontact printing further comprises:
(i) depositing a first compound onto the substrate to generate the second part; and
(ii) depositing a more hydrophilic compound onto the parts of the substrate where the first compound is not located to generate the more hydrophilic first part.

83-98. (canceled)

99. The method of claim 70, further comprising:
(c) placing a tissue sample on the pre-coated substrate.

100. The method of claim 99, further comprising:
(d) solvating the sample and substrate in a chamber containing a solvent.

101-103. (canceled)

104. A pre-coated substrate comprising a surface comprising a first part that is more hydrophilic than a second part, wherein the first part contains a target compound.

105-110. (canceled)

110. A method of preparing a sample substrate comprising:
(a) obtaining a substrate comprising a uncoated surface;
(b) affixing a hydrophobic substance on part of the uncoated surface to form a partially-coated surface; and
(c) contacting the partially coated surface with a proton source to form a partially-activated surface.

111-129. (canceled)
